(19) United States
(12) Patent Application Publication
(10) Pub. No.: US 2010/0268132 A1
(43) Pub. Date: Oct. 21, 2010

(54) MASSAGE DEVICE

(75) Inventors: Chichun Wu, Guangdong Province (CN); Zhao Zhang, Guangdong Province (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chichun Wu, Guangdong Province (CN)

(21) Appl. No.: 12/829,843

(22) Filed: Jul. 2, 2010

Related U.S. Application Data
(63) Continuation-in-part of application No. 12/551,078, filed on Aug. 31, 2009.
Application No. 12/551,078 is a continuation-in-part of application No. 11/625,255, filed on Jan. 19, 2007, now Pat. No. 7,731,672.
Application No. 11/625,255 is a continuation-in-part of application No. 11/082,016, filed on Mar. 16, 2005, now abandoned.
Application No. 12/551,078 is a continuation-in-part of application No. 12/103,785, filed on Apr. 16, 2008.

(30) Foreign Application Priority Data
May 11, 2004 (CN) 2004200456092
Mar. 7, 2008 (CN) 200820091616.4
Jul. 10, 2009 (CN) 200920133730.3
Aug. 31, 2009 (EP) 09169089.1
Mar. 22, 2010 (EP) 10 157 222.0

(51) Int. Cl. A61H 15/00

(52) U.S. Cl. 601/98

(57) ABSTRACT

The present invention relates to a massage device including a back massage module, a neck massage module and a support module. The back massage module comprises a back module housing, a back transmission assembly being in the back module housing and comprising a back motor and a back massage assembly mechanically coupled with the back motor and extending through the back module housing. The neck massage module comprises a neck module housing, a neck transmission assembly and a neck massage assembly. The neck transmission assembly is contained in the neck module housing and comprises a neck motor. The neck massage assembly is mechanically coupled with the neck motor and extending through the neck module housing. The support module connects the neck module housing to the back module housing.

### CROSS-REFERENCE TO RELATED PATENT APPLICATION

This application claims priority of EP application Nos. EP10157222.0, filed Mar. 22, 2010, entitled “Massage Device with a Locking Mechanism” by Chi Chun Wu, and EP09169089.1, filed Aug. 31, 2009, entitled “Massage Device,” by Chi-Chun Wu and Chi-Wu Chiang, which are incorporated herein in their entireties by reference.

This application is also a continuation-in-part of U.S. patent application Ser. No. 12/551,078 (hereinafter “the application '078”), filed Aug. 31, 2009, entitled “Massage Device,” by Chi-Chun Wu and Chi-Wu Chiang, which is incorporated herein in its entirety by reference.

The application '078 is a continuation-in-part of U.S. patent application Ser. No. 11/625,255, filed Jan. 19, 2007, entitled “Massage Device,” by Chi-Wu Chiang, which itself is a continuation-in-part of U.S. patent application Ser. No. 11/082,016, filed Mar. 16, 2005, entitled “Massage Device,” by Chi-Wu Chiang, which itself claims priority to and the benefit of, pursuant to 35 USC §119(a), Chinese patent application Serial No. 2004200456092, filed May 11, 2004, which are incorporated herein in their entireties by reference.

The application '078 is also a continuation-in-part of U.S. patent application Ser. No. 12/103,785, filed Apr. 16, 2008, entitled “A Massage Device,” by Chi-Wu Chiang, which itself claims priority to and the benefit of, pursuant to 35 USC §119(a), Chinese patent application Serial No. 200820091616.4, filed Mar. 7, 2008, entitled “A Massage Device,” by Chi-Wu Chiang, which is incorporated herein by reference in its entirety.

### FIELD OF THE INVENTION

The present invention relates generally to a massage device, and more particularly to a massage device providing both back and neck massaging effects

### BACKGROUND OF THE INVENTION

Simulated massaging or kneading of parts of the body to aid circulation or relax the muscles has gain popularity, particularly, among people who are lack of exercise. The simulated massaging or kneading effects can be achieved electromagnetically and/or mechanically by means of a massage device. For the electromagnetic massaging or kneading, such an electromagnetic massage device is configured to generate a series of electromagnetic pulses, which are regularly directed to parts of interest of the body so as to perform massaging or kneading thereon. However, the massaging or kneading area of the massage device is limited and the massaging or kneading effects may not be very gentle.

For the mechanical massaging or kneading, the mechanical massage device is usually designed to have multiple massage nodes and a driving system to drive the massage nodes to rotate so as to stimulate massaging or kneading when applied to parts of interest of the body. Comparing to the electromagnetic massaging, the limitation of the massaging or kneading area is improved for the mechanical massaging. However, the massaging or kneading area of the conventional mechanical massage device is limited in either the back or the neck of the body.

Therefore, a heretofore unaddressed need exists in the art to address the aforementioned deficiencies and inadequacies.

### SUMMARY OF THE INVENTION

The present invention, in one aspect, relates to a massage device. In one embodiment, the massage device includes a back massage module, a neck massage module and a support module.

The back massage module comprises a back module housing, a back transmission assembly and a back massage assembly. The back transmission assembly is contained in the back module housing and comprises a back motor. The back massage assembly is mechanically coupled with the back motor and extending through the back module housing so that when the back motor is activated, the back massage assembly provides a back massage effect.

The neck massage module comprises a neck module housing, a neck transmission assembly and a neck massage assembly. The neck transmission assembly is contained in the neck module housing and comprises a neck motor. The neck massage assembly is mechanically coupled with the neck motor and extending through the neck module housing so that when the neck motor is activated, the neck massage assembly provides a neck massage effect.

The support module connects the neck module housing to the back module housing.

In one embodiment, the support module comprises a guiding member and the neck module housing comprises a sliding member coupled with the guiding member so that the sliding member is movable back and forth along the guiding member.

In one embodiment, the guiding member is a rod having a fixing end mounted to the back module housing and an opposite, guiding end. The sliding member is a hole receiving the guiding end.

In one embodiment, the neck massage assembly comprises a pair of massage member. Each of the massage member comprises a eccentric block, a driving shaft, a massage head and an elastic member. The eccentric block has a bottom surface and a top surface tilted to the bottom surface at an angle β. One end of the driving shaft extends through the neck module housing and is mechanically coupled with the neck motor. The other end of the driving shaft is inserted in the eccentric block via the bottom surface. One end of the elastic member is secured to the eccentric block via the top surface and the other end of the elastic member is secured to the massage head. Preferably, the massage head, for example, comprises an energy source of capable of generating thermal energy.

In one embodiment, the massage device further comprises a carriage having a groove. The back module housing comprises a base cover comprising a guiding rail. The groove receives the guiding rail, so that the carriage is movable back and forth along the guiding rail.

In one embodiment, the massage device further comprises a rack secured in the base cover and parallel to the guiding rail. The back transmission assembly further comprises a worm mechanically coupled with an output shaft of the back motor, a pair of worm wheels meshing with the worm, a first gear coaxially mounted under one of the pair of the worm wheel, a second gear meshing with the first gear, a pinion gear coaxially extended under the second gear, a third gear meshing with the pinion gear and the rack. Accordingly, when the back motor is activated, the output shaft drives the worm to rotate and the rotation of the worm results in, in turn, the rotation of the pair of worm wheels, the first gear, the second gear, the pinion gear, the third gear, thereby moving the carriage along the guiding rail.

In one embodiment, the back massage assembly comprises a pair of massage members. Each of the massage member comprises a driving block, a driving shaft, multiple massage heads and multiple elastic members. The driving block has a bottom surface and a top surface. One end of the driving shaft is extending through the carriage and mechanically coupled with the back motor, and the other end of the driving shaft is inserted in the driving block via the bottom surface. The elastic members connect the top surface of the driving block to the massage heads.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows a exploded view of a massage device according to one embodiment of the present invention;

FIG. 2 shows a cross section view of the eccentric block of the massage device in FIG. 1; and

FIG. 3 shows a perspective view of the massage device as shown in FIG. 1

### DETAILED DESCRIPTION OF THE INVENTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, the terms “comprising,” “including,” “having,” “containing,” “involving,” and the like are to be understood to be open-ended, i.e., to mean including but not limited to.

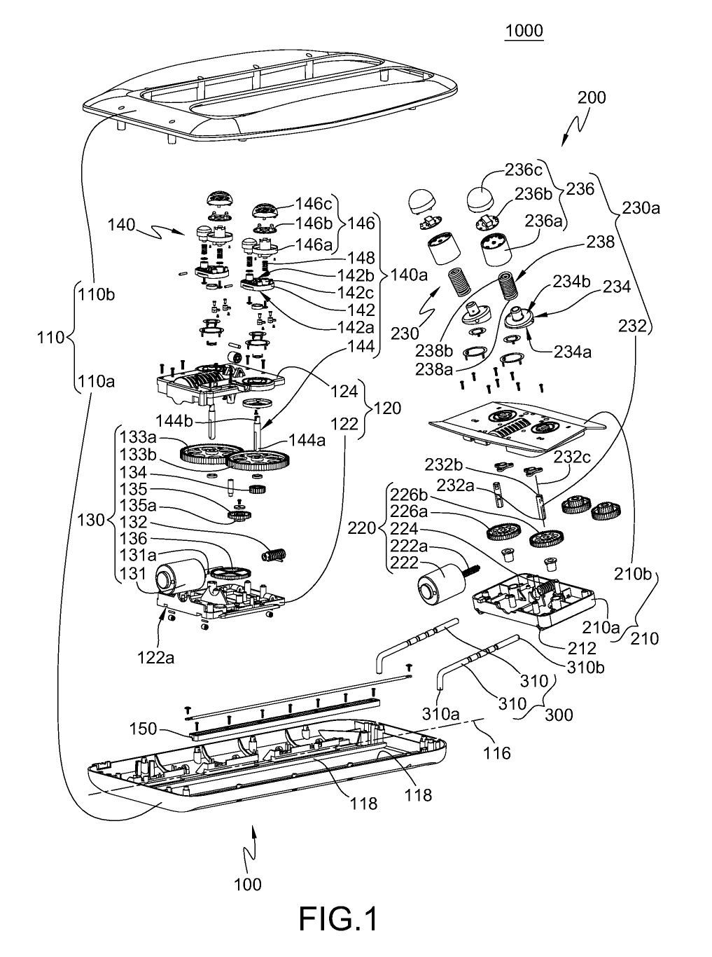

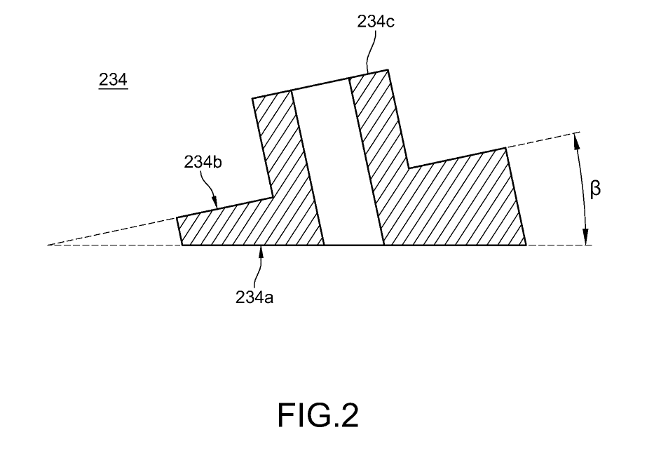

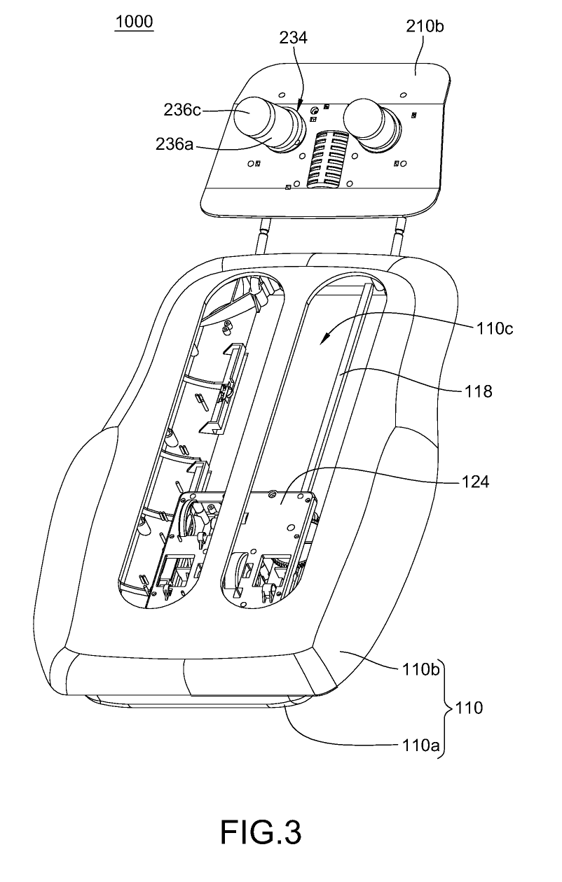

The description will be made as to the embodiments of the invention in conjunction with the accompanying drawings in FIGS. 1-3. In accordance with the purposes of the invention, as embodied and broadly described herein. This invention, in one aspect, relates to a massage device that is capable of simultaneously providing both back and neck massaging effects.

Referring to FIG. 1-3, a massage device is shown according to one embodiment of the present invention. The massage device comprises a back massage module, a neck massage module and a support module connecting the neck massage module to the back massage module.

The back massage module comprises a back module housing, a back transmission assembly and a back massage assembly. The back module housing comprises, for example, a base cover and a top cover. The top cover is over the base cover so as to define a chamber therebetween.

The back transmission assembly is contained in the back module housing, i.e. inside the chamber, and comprises a back motor. The back massage assembly mechanically coupled with the back motor and extending through the back module housing, so that when the back motor is activated, the back massage assembly provides a back massage effect.

In this embodiment, to make the back massage assembly capable of being moved along a longitudinal axis of the back module housing, the massage device may further comprise a carriage comprising a chassis member and a shield member over the chassis member. The chassis member together with the shield member contains the back transmission assembly. The back massage assembly is disposed on the shield member and mechanically coupled with the back motor. The chassis member has a pair of grooves. The base cover further has two guiding rails formed parallel to the longitudinal axis. The pair of the grooves respectively receives the pair of the guiding rails, so that the back massage assembly disposed on carriage is moveable back and forth along the guiding rails. Other numbers of guiding rails and grooves corresponding to the guiding rails can also be utilized to practice the present invention.

An example of mechanically coupling the back massage assembly with the back motor is described as following. As shown in FIG. 1, the back transmission assembly, for example, further comprises a worm mechanically coupled with an output shaft of the back motor and a pair of worm wheels meshing with the worm. The back massage assembly, for example, comprises a pair of massage members. Each of the massage member comprises a driving block, a driving shaft, two massage heads and two elastic members. The driving block has a bottom surface and a top surface. One end of the driving shaft extends through the carriage, specifically the shield member, and coaxially coupled with one of the worm wheels which meshes with the worm so as to mechanically coupled with the back motor, and the other end of the driving shaft inserted in the driving block via the bottom surface. The elastic member, for example a spring, connects the top surface of the driving block to the of massage heads. Accordingly, when the back motor is activated, the output shaft drives the worm to rotate. The rotation of the worm results in, in turn, the rotations of the pair of the worm wheels, the driving shafts, the driving blocks, the elastic members and massage heads, thereby providing a massage effect for the back of a user.

In the embodiment shown in FIGS. 1-3, each massage head has a mushroom-shape. Each massage head has a first structure, a mushroom-shape node and a second structure placed between the first structure and the mushroom-shape node. Each massage head may include an energy source capable of generating thermal energy. The energy source may include a lamp base mounted to the corresponding one of protrusions, a PCB board attached to the lamp base, and heating lamps attached onto the PCB board. For example, the first structure and the second structure of a massage head can be parts of the energy source.

Furthermore, to make the back massage assembly capable of automatically moving along the guiding rails, the massage device may further comprise a rack secured in the base cover, parallel to the guiding rails and operably cooperated with the back motor. An example of rack operably cooperating with the back motor is described as following. In addition to the worm, the pair of the worm wheels, the back transmission assembly may further comprise a first gear coaxially mounted under one of the pair of the worm wheel, a second gear meshing with the first gear, a pinion gear coaxially extended under the second gear, a third gear meshing with the pinion gear and the rack, such that when the back motor is activated, the output shaft drives the worm to rotate. The rotation of the worm results in, in turn, the rotation of the pair of worm wheels, the first gear, the second gear, the pinion gear and the third gear meshing with the rack, thereby automatically moving the carriage along the guiding rail.

The neck massage module comprises a neck module housing, a neck transmission assembly and a neck massage assembly. The neck transmission assembly is contained in the neck module housing and comprises a neck motor. The neck massage assembly is mechanically coupled with the neck motor and extending through the neck module housing so that when the neck motor is activated, the neck massage assembly provides a neck massage effect.

In this embodiment, the neck module housing comprises a base shell and a top shell together with the base shell for containing the neck transmission assembly.

The neck massage assembly comprises a pair of massage member. Each of the massage member comprises a eccentric block, a driving shaft, a massage head, and elastic member, for example, a spring. The eccentric block has a bottom surface and a top surface tilted to the bottom surface at an angle β. One end of the driving shaft extends through the top shell and is mechanically coupled with the neck motor. The other end of the driving shaft is inserted in the eccentric block via the bottom surface. One end of the elastic member is secured to the eccentric block via the top surface and the other end of the elastic member is secured to the massage head.

An example of mechanically coupling the end of the driving shaft with the neck motor is shown in FIG. 1. The neck transmission assembly may further comprise a worm meshing with an output shaft of the neck motor and a pair of worm gears meshing with the worm. The ends of the driving shafts is respectively coaxially coupled with the pair of the worm gears so as to mechanically coupling with the driving shaft with the neck motor. Accordingly, when the neck motor is activated, the output shaft drives the worm to rotate, so that the rotation of the worm results in, in turn, the rotations of the pair of the worm gears, the pair of the driving shafts, the pair of the eccentric blocks, the pair of the elastic members and the pair of the massage heads, thereby providing a massage effect for the neck of a user.

In this embodiment shown in FIGS. 1-3, each massage head has a mushroom-shape. Each massage head has a first structure, a mushroom-shape node and a second structure placed between the first structure and the mushroom-shape node. Each massage head may include an energy source capable of generating thermal energy. The energy source may include a lamp base mounted to the corresponding top surface, a PCB board attached to the lamp base, and heating lamps attached onto the PCB board. For example, the first structure and the second structure of a massage head can be parts of the energy source.

The support module connects the neck module housing to the back module housing. In this embodiment, to make the neck massage module capable of moving with respect to the back massage module, the support module may further comprises a guiding member, for example a rod. The rod has a fixing end mounted to the back module housing and a opposite, guiding end. The neck module housing may further comprises a sliding member, for example a hole. The hole receives the guiding end, so that the neck module housing is moveable back and forth along the rod.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A massage device, comprising:
a back massage module, comprising:
a back module housing;
a back transmission assembly, contained in the back module housing 110 and comprising a back motor; and
a back massage assembly mechanically coupled with the back motor and extending through the back module housing so that when the back motor is activated, the back massage assembly provides a back massage effect;
a neck massage module, comprising:
a neck module housing;
a neck transmission assembly, contained in the neck module housing and comprising a neck motor; and
a neck massage assembly, mechanically coupled with the neck motor and extending through the neck module housing so that when the neck motor is activated, the neck massage assembly provides a neck massage effect; and
a support module, connecting the neck module housing to the back module housing.

2. The massage device of claim 1, wherein the support module comprises a guiding member and the neck module housing comprises a sliding member coupled with the guiding member so that the sliding member is movable back and forth along the guiding member.

3. The massage device of claim 2, wherein the guiding member is a rod having a fixing end mounted to the back module housing and an opposite, guiding end and the sliding member is a hole receiving the guiding end.

4. The massage device of claim 1, wherein The neck massage assembly comprises a pair of massage member, each of the massage member comprises:
a eccentric block, having a bottom surface and a top surface tilted to the bottom surface at an angle β;
a driving shaft, one end of the driving shaft extending through the neck module housing and mechanically coupled with the neck motor, and the other end of the driving shaft inserted in the eccentric block via the bottom surface;
a massage head; and
an elastic member, one end of the elastic member secured on the top surface of the protrusion and the other end of the elastic member secured to the massage head.

5. The massage device of claim 4, wherein the massage head comprises an energy source of capable of generating thermal energy.

6. The massage device of claim 1, further comprising a carriage having a groove, the back module housing comprising a base cover comprising a guiding rail, the groove receiving the guiding rail so that the carriage is movable back and forth along the guiding rail.

7. The massage device of claim 6, further comprising a rack secured in the base cover and parallel to the guiding rail, the back transmission assembly further comprising a worm mechanically coupled with an output shaft of the back motor, a pair of worm wheels meshing with the worm, a first gear coaxially mounted under one of the pair of the worm wheel, a second gear meshing with the first gear, a pinion gear coaxially extended under the second gear, a third gear meshing with the pinion gear and the rack, such that when the back motor is activated, the output shaft drives the worm to rotate, and the rotation of the worm results in, in turn, the rotation of the pair of worm wheels, the first gear, the second gear, the pinion gear, the third gear, thereby moving the carriage along the guiding rail.

8. The massage device of claim 1, wherein the back massage assembly comprises a pair of massage members, each of the massage member comprises:
a driving block, having a bottom surface and a top surface;
a driving shaft, one end of the driving shaft extending through the carriage and mechanically coupled with the back motor, and the other end of the driving shaft inserted in the driving block via the bottom surface;
a plurality of massage heads; and
a plurality of elastic members, connecting the top surface of the driving block to the plurality of massage heads.

9. The massage device of claim 8, wherein the massage head comprises an energy source of capable of generating thermal energy.
